(19) United States
(12) Patent Application Publication
(10) Pub. No.: US 2008/0018720 A1
(43) Pub. Date: Jan. 24, 2008

(54) Ink cartridge

(75) Inventors: Takashi Fukushima, Kawasaki-shi (JP); Toshihiko Ujita, Yokohama-shi (JP); Akihiko Shimomura, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/812,272

(22) Filed: Jun. 18, 2007

(30) Foreign Application Priority Data
Jul. 19, 2006 (JP) 2006-196759

(51) Int. Cl. B41J 2/175

(52) U.S. Cl. 347/86

(57) ABSTRACT

An ink cartridge for an ink jet recording apparatus is formed by a material including an ethylene-propylene random copolymer and a nucleating agent containing a specified organic phosphoric acid ester compound. The material advantageously contains a nucleating agent of from 0.01 to 1.0 part by mass with respect to 100 parts by mass of ethylene-propylene copolymer, and hydrotalcite as a neutralizing agent.

### BACKGROUND OF THE INVENTION

1. Field of the Invention

The present invention relates to an ink cartridge for an ink jet recording apparatus.

2. Description of the Related Art

As one of recording apparatuses for recording an image including a character and the like (hereinafter also called printing) on a recording medium such as paper or a thin plastic sheet (such as an OHP sheet), there is known an ink jet recording apparatus which executes a printing by discharging a small ink liquid droplet. The printing by the ink jet recording apparatus has various advantages such as capability of high-speed recording, an easy recording of a color image, capability of printing not only on paper but also other recording media such as a cloth, a low noise level and capability of high-quality printing.

As an ink supply source for various recording apparatuses such as the ink jet recording apparatus, an ink cartridge which is detachably mounted on the recording apparatus is adopted. The ink cartridge for the ink jet recording apparatus is mainly classified into following two types.

One type is an ink cartridge of a construction in which a recording head portion and an ink cartridge for ink supply are integrated (cf. Japanese Patent Application Laid-Open No. S63-087242). The other type is a separately replaceable ink cartridge, which is independently separated from the ink jet recording head portion and is connected therewith through an ink introducing tube.

In the above-described ink cartridge for the ink jet recording apparatus, there is provided an ink absorbent member of a porous material, which generates a negative pressure by a capillary force, thereby suppressing an ink leakage at the attaching/detaching of the ink cartridge and holding the ink of a necessary amount within the ink absorbent member.

The ink held in the ink absorbent member is guided, by the capillary force of the nozzle of the ink jet recording head, from an ink supply opening, provided in the ink cartridge, to the ink jet recording head. The negative pressure mentioned above is further regulated appropriately, in order that the ink does not leak from the recording head and in order to maintain an ink meniscus for enabling normal ink discharge even during a stand-by state as an on-demand ink jet.

When such ink cartridge is handled singly for example in the course of distribution, a cap is mounted on the ink supply opening, in order to prevent ink leakage from the ink supply opening and to facilitate transportation. In order to securely seal the ink supply opening, a sealing member of an elastic material is provided so as to close the opening, and the cap and the ink cartridge are fused through the sealing member, thereby avoiding the liquid leakage. For fusing the cap and the ink cartridge, adopted is a method of forming plural fusible portions on an edge portion of the cap so as to protrude toward the ink cartridge, and ultrasonic fusing a contact surface between the fusible portions and the ink cartridge.

In the ink cartridge of either type, that is the type integral with the recording head or the separable type, the positioning of the ink cartridge in mounting on a carriage or the like in the ink jet recording apparatus is an important matter relating to the print quality. The attach/detach mechanism, for positioning such ink cartridge on the carriage or the like, is proposed in various forms. For example, there is proposed an ink cartridge having an engaging portion on a lateral face thereof and an elastic latch lever on the other lateral face, for respective engagement with engaging portions disposed on a holder of the ink jet head (Japanese Registered Patent No. 2801149).

Also in the ink jet recording apparatus, in the case that the ink in the cartridge is exhausted in the course of a recording operation, the recorded prints are wasted, and the recording head may cause a failure because of so-called idle recording without the ink supply. Therefore proposed is a mechanism of detecting a remaining ink amount in the ink cartridge. For detecting the remaining ink amount in the ink cartridge, already developed are a mechanism of forming electrodes in the ink cartridge and detecting an electrical conduction between the electrodes, and a mechanism of executing an optical detection. In particular, the optical detection system is employed frequently as it is simple in structure and does not require a large apparatus. A specific example of such mechanism includes a light emitting/receiving portion provided in the ink jet recording apparatus and a prism of a translucent material, disposed on a bottom portion of the ink cartridge, and detects presence/absence of the ink by the reflected light which is introduced into the light receiving portion through the prism reflective surface and is emitted from the light emitting portion, utilizing a difference in the refractive index between in the ink and in the air (Japanese Patent Application Laid-Open Nos. H02-102062 and H07-218321).

A material for such ink cartridge for ink jet has to meet following requirements.

1. To have an ink resistance, not to be dissolved by the ink to be contained;

2. Not to cause a change in the composition of ink components;

3. To be inexpensive in the material cost and the working cost, for use in a consumable supply;

4. To be recyclable in consideration of recently increasing concern for the global environment;

5. To have a relatively small shrinkage rate in molding;

6. To have a high rigidity; and

7. To be transparent.

Examples of the material meeting these requirements include resins such as denatured PPO (manufactured by Nippon GE Plastics Co., Asahi-Kasei Chemicals Co., Mitsubishi Engineering Plastics Co. etc.), PS, PBT, PET, and PP. Among these, polymers of propylene are employed often as the material for ink cartridge, as they are inexpensive and have a high gas barrier property and a high solvent resistance. Among the propylene polymers, an ethylene-propylene random copolymer has a higher transparency and a smaller molding shrinkage rate in comparison with a propylene homopolymer or a propylene block copolymer, and is employed frequently as the material for the cartridge which has to be installed with precise positioning. Also a sorbitol type nucleating agent is added in order to improve the transparency and to provide rigidity in the ethylene-propylene random copolymer.

As the nucleating agent, a sorbitol type nucleating agent, represented by 2,4-dibenzylidenesorbitol, is employed commonly. Such sorbitol type nucleating agent is relatively easily dissolved out in the ink, and such dissolved substance may be deposited depending on the environmental condition and may be accumulated, in certain cases, in an ink flow path filter of the printer or in an ink nozzle, thus detrimentally affecting the printing.

It is possible to dispense with the nucleating agent in order to prevent a print failure resulting from dissolution, but, in an ink cartridge having an optical detecting apparatus for the remaining ink amount, an ink or a bubble may remain on the optically reflecting face depending on the type of the ink to reduce the detecting margin and to require a higher transparency.

Also the ethylene-propylene random copolymer is lower in elasticity in comparison with other propylene polymers, and may be deficient in the attach/detaching property (repulsive property) on the ink jet recording apparatus. It is also flexible, so that, when the user presses the ink cartridge, the interior of the ink cartridge may be pressurized to eventually cause an ink leakage from the supply opening. Though such ink leakage can be prevented by increasing the wall thickness of the ink cartridge, such thicker wall increases the volume of the ink cartridge, thus being disadvantageous in space and in cost. Furthermore, the ethylene-propylene random copolymer has a low crystallization temperature, thus involving a drawback of requiring a long time in a molding cycle and in a fusing tact time with other members. Also, polypropylene contains a neutralizing agent, in order to prevent an influence of a residue of the catalyst employed at the polymerization. The neutralizing agent is generally a metal salt of a fatty acid, such as calcium stearate. It is also easily dissolved out in the ink, and such dissolved substance may be eventually deposited depending on the environmental condition and may be accumulated, in certain cases, in an ink flow path filter of the printer or in an ink nozzle, thus detrimentally affecting the printing.

On the other hand, it is also known, in the molded polypropylene article, to use a nucleating agent of an organic phosphoric acid ester type, in order to improve rigidity and transparency (Japanese Patent Application Laid-Open Nos. 2002-265710, H05-222078, H10-298367 and H09-087452), but no product has been developed as the cartridge material for the ink jet recording apparatus.

### SUMMARY OF THE INVENTION

An object of the present invention is to provide an ink cartridge having a transparency enabling a highly precise optical detection of the remaining ink amount and having a small molding shrinkage rate, thus enabling to obtain a molded article of a high dimensional precision that can be mounted with a precise positioning on an ink jet apparatus. Another object of the present invention is to provide an inexpensive ink cartridge that has a low interaction with the ink thereby suppressing a print quality failure over a prolonged period, that has a rigidity capable of suppressing an ink leakage under a pressing, and that can suppress environmental effects and can be produced efficiently and inexpensively.

It has been found that an ink cartridge having an excellent transparency and a high dimension precision can be obtained by using, as a material for the ink cartridge, an ethylene-propylene random copolymer and a nucleating agent containing a specified organic phosphoric acid ester compound. The present invention has been made, based on such finding.

Thus, the present invention provides an ink cartridge for an ink jet recording apparatus, which comprises being formed by a material including an ethylene-propylene random copolymer and a nucleating agent containing an organic phosphoric acid ester compound represented by a formula (1):

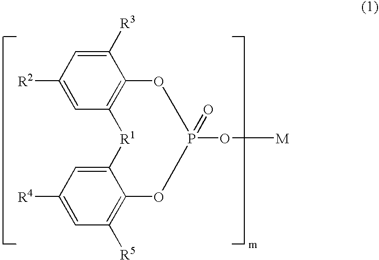

wherein R¹ represents a divalent hydrocarbon group having 1 to 10 carbon atoms; and R^{2 to R}⁵ each independently represents a hydrogen atom or an alkyl group having 1 to 12 carbon atoms; M represents a metal atom of a valence from monovalent to trivalent or an atomic group containing such metal atom; and m represents an integer from 1 to 3.

The ink cartridge of the present invention has a transparency enabling a highly precise optical detection of the remaining ink amount and has a small molding shrinkage rate, thus enabling to obtain a molded article of a high dimensional precision that can be mounted with a precise positioning on an ink jet apparatus. Also it has a low interaction with the ink thereby suppressing a print quality failure over a prolonged period, also has a rigidity capable of suppressing an ink leakage under a pressing, and can suppress an environmental effects and can be produced efficiently and inexpensively.

Further features of the present invention will become apparatus from the following description of exemplary embodiments with reference to the accompanying drawings.

### BRIEF DESCRIPTION OF THE DRAWINGS

FIG. 1 is a schematic frontal cross-sectional view illustrating an example of the ink cartridge of the present invention.

FIG. 2 is a schematic lateral view illustrating an example of the ink cartridge of the present invention.

### DESCRIPTION OF THE EMBODIMENTS

The ink cartridge of the present invention is an ink cartridge for an ink jet recording apparatus, which comprises being formed by a material including an ethylene-propylene random copolymer and a nucleating agent containing an organic phosphoric acid ester compound represented by a formula (1):

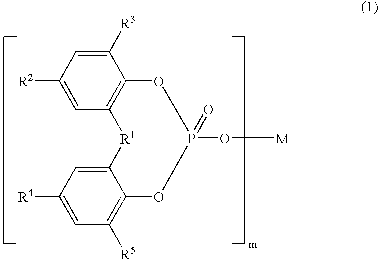

wherein R¹ represents a divalent hydrocarbon group having 1 to 10 carbon atoms; and R² to R⁵ each independently represents a hydrogen atom or an alkyl group having 1 to 12 carbon atoms; M represents a metal atom of a valence from monovalent to trivalent or an atomic group containing such metal atom; and m represents an integer from 1 to 3.

The ethylene-propylene random copolymer, to be employed in forming the ink cartridge of the present invention, may for example have a propylene content of from 10 to 99 wt % in the copolymer and an ethylene content of from 90 to 1 wt %. In the ethylene-propylene random copolymer, propylene preferably assume an isotactic structure. Also the polymer preferably has a high isotactic pentad ratio. The ethylene-propylene random copolymer may contain a third monomer component and a fourth monomer component within such an extent as not to hinder these monomer components.

The nucleating agent to be employed in forming the ink cartridge of the present invention is to have a low interaction with the ink and to have a function of providing transparency. Such nucleating agent contains an organic phosphoric acid ester compound represented by the formula (1). In the formula, R¹ represents a hydrocarbon group having 1 to 10 carbon atoms, and R² to R⁵ each independently represents a hydrogen atom or an alkyl group having 1 to 12 carbon atoms. The alkyl group may be linear, branched or cyclic. Also in the formula, M represents a metal atom of a valence from monovalent to trivalent or an atomic group containing such metal atom; and m represents an integer from 1 to 3. Examples of M include an alkali metal such as sodium, potassium or lithium, an alkali earth metal such as calcium or magnesium, an alkali earth metal having a hydroxyl group, a trivalent metal such as aluminum or indium, and such trivalent metal having a hydroxyl group. Specific examples of such organic phosphoric acid ester compound include:
sodium 2,2′-methylene-bis(4,6-di-t-butylphenyl)-phosphate,
sodium 2,2′-methylene-bis(4-t-butyl-6-methylphenyl)phosphate,
sodium 2,2′-methylene-bis(4-t-butyl-6-ethylphenyl)-phosphate,
sodium 2,2′-methylene-bis(4,6-di-i-propylphenyl)-phosphate,
sodium 2,2′-methylene-bis(4-i-propyl-6-methylphenyl)phosphate,
sodium 2,2′-methylene-bis(4-i-propyl-6-ethylphenyl)phosphate,
sodium 2,2′-methylene-bis(4,6-di-pentylphenyl)-phosphate,
sodium 2,2′-methylene-bis(4-pentyl-6-methylphenyl)-phosphate,
sodium 2,2′-methylene-bis(4-pentyl-6-ethylphenyl)-phosphate,
sodium 2,2′-ethylene-bis(4,6-di-t-butylphenyl)-phosphate,
sodium 2,2′-ethylene-bis(4-t-butyl-6-methylphenyl)-phosphate,
sodium 2,2′-ethylene-bis(4-t-butyl-6-ethylphenyl)-phosphate,
sodium 2,2′-ethylene-bis(4,6-di-i-propylphenyl)-phosphate,
sodium 2,2′-ethylene-bis(4-i-propyl-6-methylphenyl)phosphate,
sodium 2,2′-ethylene-bis(4-i-propyl-6-ethylphenyl)phosphate,
sodium 2,2′-ethylene-bis(4,6-di-pentylphenyl)-phosphate,
sodium 2,2′-ethylene-bis(4-pentyl-6-methylphenyl)-phosphate,
sodium 2,2′-ethylene-bis(4-pentyl-6-ethylphenyl)-phosphate,
sodium 2,2′-trimethylene-bis(4,6-di-t-butylphenyl)-phosphate,
sodium 2,2′-tetramethylene-bis(4,6-di-t-butylphenyl)phosphate,
sodium 2,2′-t-octylmethylene-bis(4,6-di-t-butylphenyl)phosphate,
calcium bis[2,2′-methylene-bis(4,6-di-t-butylphenyl)phosphate],
calcium bis[2,2′-methylene-bis(4-t-butyl-6-methylphenyl)phosphate],
calcium bis[2,2′-methylene-bis(4-t-butyl-6-ethylphenyl)phosphate],
calcium bis[2,2′-methylene-bis(4,6-di-i-propylphenyl)phosphate],
calcium bis[2,2′-methylene-bis(4-i-propyl-6-methylphenyl)phosphate],
calcium bis[2,2′-methylene-bis(4-i-propyl-6-ethylphenyl)phosphate],
calcium bis[2,2′-methylene-bis(4,6-di-pentylphenyl)phosphate],
calcium bis[2,2′-methylene-bis(4-pentyl-6-methylphenyl)phosphate],
calcium bis[2,2′-methylene-bis(4-pentyl-6-ethylphenyl)phosphate],
calcium bis[2,2′-ethylene-bis(4,6-di-t-butylphenyl)phosphate],
calcium bis[2,2′-ethylene-bis(4-t-butyl-6-methylphenyl)phosphate],
calcium bis[2,2′-ethylene-bis(4-t-butyl-6-ethylphenyl)phosphate],
calcium bis[2,2′-ethylene-bis(4,6-di-i-propylphenyl)phosphate],
calcium bis[2,2′-ethylene-bis(4-i-propyl-6-methylphenyl)phosphate],
calcium bis[2,2′-ethylene-bis(4-i-propyl-6-ethylphenyl)phosphate],
calcium bis[2,2′-ethylene-bis(4,6-di-pentylphenyl)-phosphate],
calcium bis[2,2′-ethylene-bis(4-pentyl-6-methylphenyl)phosphate],
calcium bis[2,2′-ethylene-bis(4-pentyl-6-ethylphenyl)phosphate],
calcium bis[2,2′-trimethylene-bis(4,6-di-t-butylphenyl)phosphate],
calcium bis[2,2′-tetramethylene-bis(4,6-di-t-butylphenyl)phosphate], and
calcium bis[2,2′-t-octylmethylene-bis(4,6-di-t-butylphenyl)phosphate].

Further examples include:
aluminum tris[2,2′-methylene-bis(4,6-di-t-butylphenyl)phosphate],
aluminum tris[2,2′-methylene-bis(4-t-butyl-6-methylphenyl)phosphate],
aluminum tris[2,2′-methylene-bis(4-t-butyl-6-ethylphenyl)phosphate],
aluminum tris[2,2′-methylene-bis(4,6-di-i-propylphenyl)phosphate],
aluminum tris[2,2′-methylene-bis(4-i-propyl-6-methylphenyl)phosphate],
aluminum tris[2,2′-methylene-bis(4-i-propyl-6-ethylphenyl)phosphate],
aluminum tris[2,2′-methylene-bis(4,6-di-pentylphenyl)phosphate],
aluminum tris[2,2′-methylene-bis(4-pentyl-6-methylphenyl)phosphate],
aluminum tris[2,2′-methylene-bis(4-pentyl-6-ethylphenyl)phosphate],
aluminum tris[2,2′-ethylene-bis(4,6-di-t-butylphenyl)phosphate],
aluminum tris[2,2′-ethylene-bis(4-t-butyl-6-methylphenyl)phosphate],
aluminum tris[2,2′-ethylene-bis(4-t-butyl-6-ethylphenyl)phosphate],
aluminum tris[2,2′-ethylene-bis(4,6-di-i-propylphenyl)phosphate],
aluminum tris[2,2′-ethylene-bis(4-i-propyl-6-methylphenyl)phosphate],
aluminum tris[2,2′-ethylene-bis(4-i-propyl-6-ethylphenyl)phosphate],
aluminum tris[2,2′-ethylene-bis(4,6-di-pentylphenyl)phosphate],
aluminum tris[2,2′-ethylene-bis(4-pentyl-6-methylphenyl)phosphate],
aluminum tris[2,2′-ethylene-bis(4-pentyl-6-ethylphenyl)phosphate],
aluminum tris[2,2′-trimethylene-bis(4,6-di-t-butylphenyl)phosphate],
aluminum tris[2,2′-tetramethylene-bis(4,6-di-t-butylphenyl)phosphate], and
aluminum tris[2,2′-t-octylmethylene-bis(4,6-di-t-butylphenyl)phosphate].

Further examples include:
hydroxyaluminum bis[2,2′-methylene-bis(4,6-di-t-butylphenyl)phosphate],
hydroxyaluminum bis[2,2′-methylene-bis(4-t-butyl-6-methylphenyl)phosphate],
hydroxyaluminum bis[2,2′-methylene-bis(4-t-butyl-6-ethylphenyl)phosphate],
hydroxyaluminum bis[2,2′-methylene-bis(4,6-di-i-propylphenyl)phosphate],
hydroxyaluminum bis[2,2′-methylene-bis(4-i-propyl-6-methylphenyl)phosphate],
hydroxyaluminum bis[2,2′-methylene-bis(4-i-propyl-6-ethylphenyl)phosphate],
hydroxyaluminum bis[2,2′-methylene-bis(4,6-di-pentylphenyl)phosphate],
hydroxyaluminum bis[2,2′-methylene-bis(4-pentyl-6-methylphenyl)phosphate],
hydroxyaluminum bis[2,2′-methylene-bis(4-pentyl-6-ethylphenyl)phosphate],
hydroxyaluminum bis[2,2′-ethylene-bis(4,6-di-t-butylphenyl)phosphate],
hydroxyaluminum bis[2,2′-ethylene-bis(4-t-butyl-6-methylphenyl)phosphate],
hydroxyaluminum bis[2,2′-ethylene-bis(4-t-butyl-6-ethylphenyl)phosphate],
hydroxyaluminum bis[2,2′-ethylene-bis(4,6-di-i-propylphenyl)phosphate],
hydroxyaluminum bis[2,2′-ethylene-bis(4-i-propyl-6-methylphenyl)phosphate],
hydroxyaluminum bis[2,2′-ethylene-bis(4-i-propyl-6-ethylphenyl)phosphate],
hydroxyaluminum bis[2,2′-ethylene-bis(4,6-di-pentylphenyl)phosphate],
hydroxyaluminum bis[2,2′-ethylene-bis(4-pentyl-6-methylphenyl)phosphate],
hydroxyaluminum bis[2,2′-ethylene-bis(4-pentyl-6-ethylphenyl)phosphate],
hydroxyaluminum bis[2,2′-trimethylene-bis(4,6-di-t-butylphenyl)phosphate],
hydroxyaluminum bis[2,2′-tetramethylene-bis(4,6-di-t-butylphenyl)phosphate], and
hydroxyaluminum bis[2,2′-t-octylmethylene-bis(4,6-di-t-butylphenyl)phosphate].

These compounds may be employed singly or in a combination of two or more kinds.

Among these, hydroxyaluminum bis[2,2′-methylene-bis(4,6-di-t-butylphenyl)phosphate] represented by a formula (2) (NA-21, manufactured by ADEKA Co.) may be mentioned as particularly advantageous:

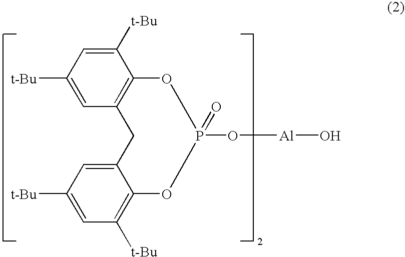

Also sodium 2,2′-methylene-bis(4,6-di-t-butylphenyl)phosphate represented by a formula (3) may be mentioned as advantageous:

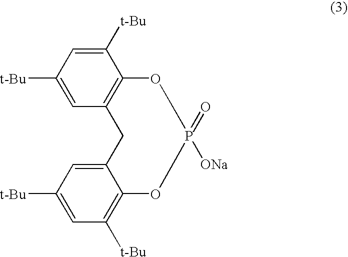

The nucleating agent containing such organic phosphoric acid ester compound is present in a content, in the cartridge forming material, preferably of from 0.01 to 1.0 part by mass, more preferably from 0.05 to 0.3 parts by mass, with respect to 100 parts by mass of the ethylene-propylene random copolymer. A content of the nucleating agent equal to or larger than 0.01 parts by mass allows to obtain a transparency and a mechanical strength in the obtained cartridge, and a content equal to or less than 1.0 part by mass allows to obtain a transparency and a mechanical strength sufficiently without unnecessary waste.

According to the invention, it is preferable that the nucleating agent has a particle diameter of from 1 μm to 10 μm. If the particle diameter of the nucleating agent to be used is too small, the nucleating agent becomes easy to attach on a manufacturing machine so that deviation of an actual compounding amount becomes large. As a result of this, it is fear that a transparency of optical prism is deviated, an accuracy of detection of ink remaining amount is lowered, and detection is incorrectly made depending on the conditions. In contrast, it is not preferable that the particle diameter is too large, because dispersion property of nucleating agent is lowered and the effect of the nucleating agent is lowered.

In the cartridge forming material mentioned above, a neutralizing agent may be contained. The neutralizing agent is employed for preventing the influence of residue of a catalyst, employed in the polymerization of the ethylene-propylene block copolymer. As such neutralizing agent, a hydrotalcite type compound (basic aluminum magnesium carbonate) may be employed. The hydrotalcite type compound shows little dissolution in the ink, thus capable of suppressing generation of deposits in the ink flow path connected to the ink jet head. A specific example is Mg_{4.3}Al₂(OH)_{12.6}CO₃.mH₂O. A content of the hydrotalcite type compound in the cartridge forming material is preferably from 0.005 to 1.5 parts by mass, more preferably from 0.05 to 0.5 parts by mass, with respect to 100 parts by mass of the ethylene-propylene random copolymer. A content of the hydrotalcite type compound equal to or larger than 0.005 parts by mass can provide a neutralizing effect, and a content equal to or less than 1.5 parts by mass can provide a sufficient neutralizing effect without unnecessary waste.

An amount of from 0.1 to 1.0 part by mass of antioxidant agent is generally compounded with respect to 100 parts by mass of the polypropylene. In the invention, in order to suppress the malfunctioning of ink cartridge due to eluation, 0.01 to 0.1 parts by mass of antioxidant agent is preferable. The ink cartridge is generally contained in a printer and is utilized in a light-shielded state, a compounding amount of antioxidant agent can be lowered. If the amount of antioxidant agent is larger than that, it is fear that eluation of antioxidant agent might influence on the printing. The antioxidant agent includes, for example, Irganox 1076 (manufactured by Ciba Specialty Chemicals), Irganox 1010 (manufactured by Ciba Specialty Chemicals), Irganox 3114 (manufactured by Ciba Specialty Chemicals), and Sumilizer GA80 (manufactured by Sumitomo Chemical Co.).

In the cartridge forming material mentioned above, if necessary, additives employed in the propylene copolymers or the like, such as an ultraviolet absorber, a filler and an antistatic may be contained within an extent not hindering the functions of the aforementioned substances.

An ink cartridge can be formed, with the aforementioned ink cartridge forming material, for example by a following method. Ethylene-propylene random copolymer is added with prescribed amounts of the nucleating agent and if necessary various additives such as the neutralizing agent, then mixed for example with a Henschel mixer, and melt kneaded with an extruder, a kneader or a Bambury mixer to obtain a resin composition in which the components are uniformly dispersed and mixed. The resin composition may be once formed into pellets and then molded into an ink cartridge of a desired shape by an injection molding, an extrusion molding or a press molding. Otherwise, it may be molded without once being formed into pellets.

The ink cartridge molded with the aforementioned material can have a haze of 75% or less for a 3 mm thickness. When an optical detecting apparatus is employed for detecting the decrease in the contained ink amount, such haze enables a detection without an error.

As the haze value, a value measured according to JIS K7105-1981 may be adopted.

Also the ink cartridge molded with the aforementioned material can have a flexural modulus of 800 MPa or higher for a 3 mm thickness. Such flexural modulus can suppress the ink leakage when the cartridge is depressed.

As the flexural modulus, a value measured according to JIS K7171-1994, under conditions of 2 mm/minute and 23° C.

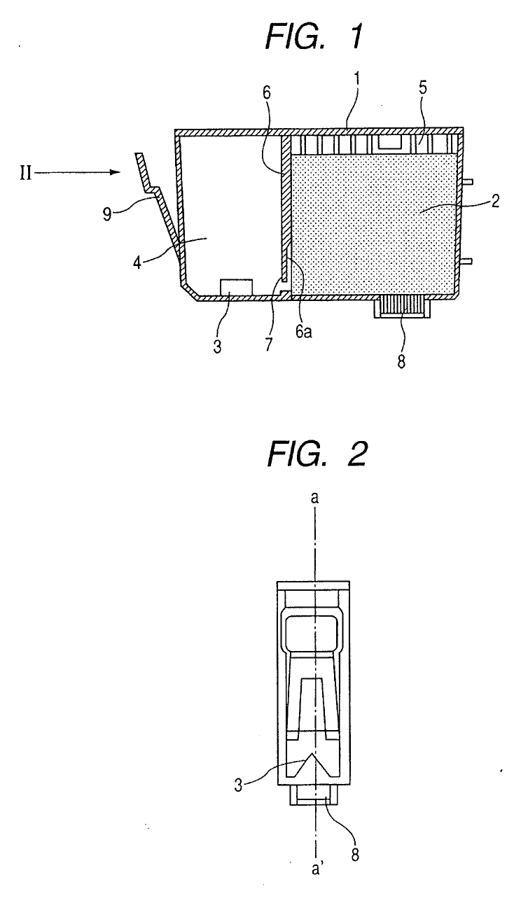

The ink cartridge of the present invention may have any structure, but an example thereof is illustrated in FIGS. 1 and 2. As illustrated in a schematic frontal cross-sectional view in FIG. 1 and a schematic lateral view in FIG. 2, a main body of an ink cartridge 1 is separated, in the interior thereof by a partition wall 6, into an ink containing chamber 4 and an absorbent member containing chamber 5. The absorbent member containing chamber 5 is provided, in an upper part thereof, with an atmosphere communication opening (not illustrated) connected to the atmosphere, and, in a lower part thereof, with an ink supply portion 8 connected with an ink jet recording head (not illustrated) for ink supply thereto. The ink containing chamber 4 communicates with the absorbent member containing chamber 5 only through a gas-liquid exchange path 7, and a porous absorbent member 2, disposed in the absorbent member containing chamber 5 and having a capillary force, is capable of absorbing and holding therein the ink contained in the ink containing chamber 4. The partition wall 6 is provided, at the side of the absorbent member containing chamber 5, with an air introducing groove 6a so as to reach the gas-liquid exchange path 7, whereby the air flowing in from the atmosphere communication opening can be introduced into the ink containing chamber through such air introducing groove.

The ink supply from such ink cartridge to the ink jet recording head is executed in the following manner. When the ink is discharged from an ink discharge port of the head in response to a signal from the ink jet recording apparatus, an ink suction force is generated in the ink discharge port. Such suction force is transmitted through the absorbent member in the absorbent member containing chamber 5 and the gas-liquid exchange path 7 to the ink in the ink containing chamber 4, whereby the ink is supplied from the ink containing chamber 4 in an amount corresponding to the discharged amount. Along with the ink supply, the internal pressure of the ink containing chamber 4, which is closed except for the gas-liquid exchange path 7, is lowered to generate a pressure difference from the absorbent member containing chamber 5 in which the air is introduced from the atmosphere communication opening. While the ink discharge is executed continuously, the pressure difference continues to increase, but the air flowing into the absorbent member containing chamber 5 enters the ink containing chamber 4 through the absorbent member 2 and through the gas-liquid exchange path 7. At this point, the pressure difference between the ink containing chamber 4 and the absorbent member containing chamber 5 is resolved. This operation is repeated during the operation of the ink jet recording apparatus. In this operation, as the air flows into the air introducing groove 6a formed on the partition wall 6, an ink-air meniscus is stably formed in the gas-liquid exchange path 7 and the vicinity thereof, whereby the ink supply from the ink containing chamber 4 to the absorbent member containing chamber 5 is executed smoothly. Also the air introduction from the absorbent member containing chamber 5 to the ink containing chamber 4 is executed by constantly and promptly breaking the ink-air meniscus formed in the gas-liquid exchange path 7 and the vicinity thereof. In this manner, while the ink discharge operation is continued, the ink supply from the ink containing chamber 4 to the absorbent member containing chamber 5 and the air supply from the absorbent member containing chamber 5 to the ink containing chamber 4 can be executed smoothly while maintaining a prescribed negative pressure in the cartridge.

The ink cartridge also has a latch lever 9, which is an elastic lever having an engaging portion 9a and protrudes from an external wall of the ink cartridge. The engaging portion of the latch lever enables easy positioning and mounting for example on a carriage for the ink jet recording head, and also enables easy attaching and detaching. When the consumption of ink is detected by an ink amount detection apparatus to be described later, the latch lever can be operated to detach the ink cartridge from the carriage or the like for replacement with an ink cartridge filled with the ink.

In the ink cartridge of the invention, a detection apparatus is provided for detecting the ink amount contained in the ink containing chamber. The detection apparatus for example includes a prism 3 disposed in a bottom portion in the ink containing chamber, and a light emitting/receiving apparatus (not illustrated) having a light emitting portion for irradiating the prism with a light and a light receiving portion for receiving the light transmitted by the prism, and can detect the remaining ink amount by the light received by the light receiving portion. The ink cartridge of the invention, having a high transparency, facilitates the optical detection of the remaining ink amount, thereby enabling detection of a high precision without an error.

The ink to be contained in the ink cartridge of the present invention may be any ink usable in the ink jet recording apparatus. A specific example is a black-color ink having a formulation of purified water/glycerin/Food Black Z (water-soluble black dye)/N-methylpyrrolidone (70/15/3/12 (parts by weight)), but the present invention is not limited to such example.

### EXAMPLES

In the following, the ink cartridge of the present invention will be clarified in more details by examples, but the technical scope of the present invention is not limited by such examples.

### Example 1

(Resin Molding)

100 parts by mass of an ethylene-propylene random copolymer, 0.3 parts by mass of an organic phosphoric acid ester compound, 0.05 part by mass of neutralizing agent, and 0.05 part by mass of antioxidant agent were mixed, and injection molded by an extruder to prepare a test piece of a thickness of 3 mm and an ink cartridge having a prism portion. A sodium 2,2′-methylene-bis(4,6-di-t-butylphenyl)phosphate (NA-11: manufactured by ADEKA Co., particle diameter: 5-10 μm) represented by a formula (3) as an organic phosphoric acid ester compound, 0.05 part by mass of Irganox 1010 (manufactured by Ciba Specialty Chemicals) which is disclosed in Japanese Patent Application Laid-Open No. 2006-199914 (Matsusihita Electric Woks LTD) and so on, as the antioxidant agent, and 0.05 parts by mass of DHT-4A (manufactured by Kyowa Chemical Co.) which is disclosed in Japanese Patent Application Laid-Open No. H05-22225 (Asahi Denka Kogyo K.K.) and so on, as the neutralizing agent were mixed, and injection molded by an extruder to prepare a test piece of a thickness of 3 mm and an ink cartridge having a prism portion.

(Dissolution Test in Ink)

The obtained test piece was immersed in a test ink and heated at 100° C. for 10 hours in a PCT (pressure cooker tester). After cooling to the normal temperature, the test ink was subjected to a measurement of ultraviolet-visible absorption spectrum. Obtained result is shown in Table 1.

(Evaluation of Transparency)

The obtained test piece was subjected to a haze measurement according to JIS K7105-1981. Obtained result is shown in Table 2. A lower haze value indicates a higher transparency.

(Measurements of Flexural Modulus and rigidity)

The obtained test piece was subjected to a measurement of flexural modulus according to JIS K7171-1994. Obtained result is shown in Table 3.

(Measurement of Crystallizing Temperature)

Pellets of the resin composition were prepared and subjected to a DSC measurement by a differential scanning calorimeter (DSC822, manufactured by Mettler-Toledo Co.). Obtained result is shown in Table 4.

(Measurement of Actual Configuration)

An evaluation of reflective light amount of ink cartridge having a prism portion was performed, and an evaluation of printing influenced by eluation matter in ink while an ink carriage is stored at a high temperature. Obtained result is shown in Table 5.

### Example 2

A test piece was prepared in the same manner as in Example 1 except that sodium 2,2′-methylene-bis(4,6-di-t-butylphenyl)phosphate (NA-11, manufactured by ADEKA Co.) was replaced by hydroxyaluminum bis[2,2′-methylene-bis(4,6-di-t-butylphenyl)phosphate] represented by the formula (2) (NA-21, manufactured by ADEKA Co.).

### Comparative Example 1

A test piece was prepared in the same manner as in Example 1 except that sodium 2,2′-methylene-bis(4,6-di-t-butylphenyl)phosphate (NA-11, manufactured by ADEKA Co.) was replaced by bis(p-methylbenzylidene)sorbitol (Gelol DH, manufactured by New Japan Chemical Co.).

### Comparative Example 2

A test piece was prepared in the same manner as in Example 1 except that sodium 2,2′-methylene-bis(4,6-di-t-butylphenyl)phosphate (NA-11, manufactured by ADEKA Co.) was not used.

### Comparative Example 3

An ink cartridge was prepared in the same manner as in Example 1 except that a particle diameter of sodium 2,2′-methylene-bis(4,6-di-t-butylphenyl)phosphate (NA-11, manufactured by ADEKA Co.) was 1 μm or less.

### Comparative Example 4

An ink cartridge was prepared in the same manner as in Example 1 except that a compounding amount of antioxidant was 0.2 parts by mass.

TABLE 1

| | Polymer | Nucleating | Maximum |
|---|---|---|---|
| Sample | structure | agent | absorbance |
| Example 1 | EP random | NA21 | 0.5 |
| Example 2 | EP random | NA11 | 0.5 |
| Comp. | EP random | G. DH | 2.4 |
| Example 1 | | | |
| Comp. | EP random | not added | 0.3 |
| Example 2 | | | |

As organic dissolved substance generally has an absorption band in the ultraviolet region, a lower absorbance can be considered to indicate a smaller amount of the dissolved substance. Based on the results, the ink cartridge of the present invention has an absorbance smaller than in Comparative Example 1 and comparable to that of Comparative Example 2 in which the nucleating agent was not added, thus clearly indicating a very small dissolution.

TABLE 2

| | Polymer | Nucleating | |
|---|---|---|---|
| Sample | structure | agent | Haze [%] |
| Example 1 | EP random | NA21 | 46 |
| Example 2 | EP random | NA11 | 68 |
| Comp. | EP random | G. DH | 33 |
| Example 1 | | | |
| Comp. | EP random | not added | 85 |
| Example 2 | | | |

It is generally known that a haze value of 80% or higher for a 3 mm thickness may hinder, though very rarely, the normal function of the optical detection apparatus due to an influence of the ink or bubble remaining on the optical reflecting face. Based on the results, the ink cartridge of the present invention had haze values of 68% and 46%, thus clearly indicating a high transparency.

TABLE 3

| | | | Flexural |
|---|---|---|---|
| | Polymer | Nucleating | modulus |
| Sample | structure | agent | [MPa] |
| Example 1 | EP random | NA21 | 840 |
| Example 2 | EP random | NA11 | 845 |
| Comp. | EP random | not added | 740 |
| Example 2 | | | |

Based on the results, the ink cartridge of the present invention has a high flexural modulus. It is evident that the ink cartridge of the present invention has an elasticity in the latch lever, thus enabling satisfactory attaching to and detaching/from the ink jet recording apparatus, and has a higher rigidity in comparison with the ink cartridge of a same thickness, thus capable of suppressing the ink leakage under depression.

TABLE 4

| | Polymer | Nucleating | |
|---|---|---|---|
| Sample | structure | agent | Tc |
| Example 1 | EP random | NA21 | 119 |
| Example 2 | EP random | NA11 | 122 |
| Comp. | EP random | G. DH | 119 |
| Example 1 | | | |
| Comp. | EP random | not added | 102 |
| Example 2 | | | |

Based on the results, the ink cartridge material of the present invention has a high crystallizing temperature (Tc), and, in the molding of the ink cartridge, can solidify at a higher temperature and can reduce the cooling time, thereby reducing the tact time.

TABLE 5

| | | Comp. | Comp. |
|---|---|---|---|
| Sample | Example 1 | Example 3 | Example 4 |
| polymer | EP random | EP random | EP random |
| structure | | | |
| Compounding | 0.05 parts | 0.05 parts | 0.2 parts |
| amount of | of mass | of mass | of mass |
| antioxidant | | | |
| agent to 100 | | | |
| parts of mass | | | |
| of resin | | | |
| Particle | 5-10 μm | 1 μm or less | 5-10 μm |
| diameter of | | | |
| nucleating | | | |
| agent | | | |
| Result | ∘ | x | x |

Based on the results, in the ink cartridge of the present invention, an actual compounding amount of nucleating agent is stabilized so that an amount of light is prevented from being lowered and a remaining amount of ink in the ink cartridge can be detected with high accuracy. Further, according to the invention, a high quality ink cartridge in which eluation matter such as an antioxidant agent and a nucleating agent rarely influences printing can be provided. In table 5, “o” of result means that light amount was not lowered and printing is not influenced by the eluation matter; and “x” means that either light amount was lowered or printing was influenced by the eluation matter.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-196759 filed Jul. 19, 2006, which is hereby incorporated by reference herein in its entirety.

What is claimed is:

1. An ink cartridge for an ink jet recording apparatus, which comprises being formed by a material including an ethylene-propylene random copolymer and a nucleating agent containing an organic phosphoric acid ester compound represented by a formula (1): 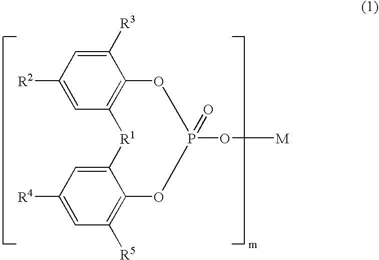
wherein R¹ represents a divalent hydrocarbon group having 1 to 10 carbon atoms; and R² to R⁵ each independently represents a hydrogen atom or an alkyl group having 1 to 12 carbon atoms; M represents a metal atom of a valence from monovalent to trivalent or an atomic group containing such metal atom; and m represents an integer from 1 to 3.

2. An ink cartridge according to claim 1, wherein the organic phosphoric acid ester compound is represented by a formula (2) or a formula (3):

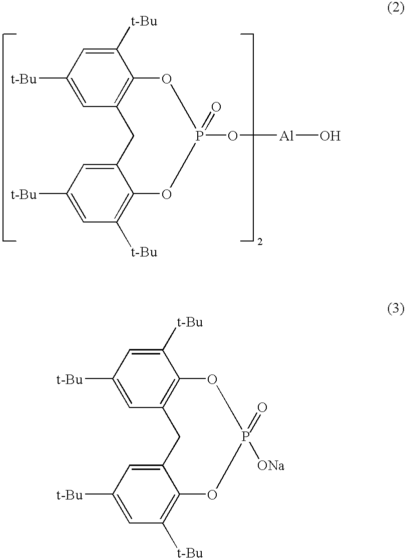

3. An ink cartridge according to claim 1, wherein said material contains a nucleating agent in an amount of from 0.01 to 1.0 part by mass with respect to 100 parts by mass of the ethylene-propylene random copolymer.

4. An ink cartridge according to claim 1, wherein the nucleating agent has a particle diameter of from 1 μm to 10 μm.

5. An ink cartridge according to claim 1, wherein said material contains hydrotalcite as a neutralizing agent.

6. An ink cartridge according to claim 5, wherein said material contains a neutralizing agent in an amount of from 0.005 to 1.5 part by mass with respect to 100 parts by mass of the ethylene-propylene random copolymer.

7. An ink cartridge according to claim 1, wherein said material contains an antioxidant agent in an amount of from 0.01 to 0.1 part by mass with respect to 100 parts by mass of the ethylene-propylene random copolymer.

8. An ink cartridge according to claim 1, wherein said material has a haze value equal to or less than 75% for a 3 mm thickness.

9. An ink cartridge according to claim 1, wherein said material has a flexural modulus equal to or larger than 800 MPa for a 3 mm thickness.

10. An ink cartridge according to claim 1, comprising an optical detecting device for detecting a remaining ink amount.

11. An ink cartridge according to claim 1, comprising an elastic lever which is formed as protruding from an external wall, for detachably mounting under positioning on an ink jet recording apparatus.
